(19) United States
(12) Patent Application Publication
(10) Pub. No.: US 2020/0001390 A1
(43) Pub. Date: Jan. 2, 2020

(54) JOINING APPARATUS AND METHOD OF JOINING

(71) Applicant: HONDA MOTOR CO., LTD., Tokyo (JP)

(72) Inventors: Takeshi Yamazaki, Tochigi-ken (JP); Takahisa Tashiro, Tochigi-ken (JP); Hiroyuki Nagai, Tochigi-ken (JP); Takefumi Yokoyama, Tochigi-ken (JP)

(21) Appl. No.: 16/455,796

(22) Filed: Jun. 28, 2019

(30) Foreign Application Priority Data
Jun. 29, 2018 (JP) 2018-124844

(51) Int. Cl. B23K 11/11; B23K 11/25

(52) U.S. Cl. CPC B23K 11/11; B23K 11/25

(57) ABSTRACT

A joining apparatus includes an electrifying/pressurizing head provided with an abutting surface contacting a pressure-receiving surface of a first metal member, joins the first metal member and a second metal member by electrification and pressurization employing the electrifying/pressurizing head, and obtains a joined body in which a joining interface inclines with respect to the pressure-receiving surface. The abutting surface includes: an electrode section capable of electrifying the first metal member; and an insulating section configured from an insulating material. At least a shortest portion where a distance from the joining interface will be shortest, of the pressure-receiving surface will be a non-contact-with-electrode section of non-contact with the electrode section, and the insulating section contacts at least part of the non-contact-with-electrode section.

### CROSS-REFERENCE TO RELATED APPLICATION

This application is based upon and claims the benefit of priority from Japanese Patent Application No. 2018-124844 filed on Jun. 29, 2018, the contents of which are incorporated herein by reference.

### BACKGROUND OF THE INVENTION

### Field of the Invention

The present invention relates to a joining apparatus and a method of joining that join a first metal member and a second metal member by electrification and pressurization.

### Description of the Related Art

For example, Japanese Laid-Open Patent Publication No. 11-090621 discloses a joining apparatus that, when joining a first metal member and a second metal member by performing electrification and pressurization between two electrodes, brings an abutting surface of one of the electrodes into contact with a pressure-receiving surface of the first metal member. In a joined body eventually obtained by this joining apparatus, a planar direction of a joining interface of the first metal member and the second metal member inclines with respect to a planar direction of the pressure-receiving surface of the first metal member.

### SUMMARY OF THE INVENTION

When the joining interface inclines with respect to the pressure-receiving surface in the above-described way, a distance between the joining interface and the pressure-receiving surface will be a length that differs for each portion of the joining interface. Of the joining interface, in a portion whose distance from the pressure-receiving surface will be shorter than that of another portion, an electrification resistance will decrease, hence a large current will flow whereby it will be easy for a generated heat amount to increase. If, as a result, variation occurs in the generated heat amount of the joining interface, then sometimes it will be difficult for the first metal member and the second metal member to be favorably joined.

A main object of the present invention is to provide a joining apparatus that can favorably join a first metal member and a second metal member.

Another object of the present invention is to provide a method of joining that can favorably join a first metal member and a second metal member.

A first aspect of the present invention is a joining apparatus that comprises an electrifying/pressurizing head provided with an abutting surface contacting a pressure-receiving surface of a first metal member, and that joins the first metal member and a second metal member by electrification and pressurization employing the electrifying/pressurizing head, and obtains a joined body in which a joining interface inclines with respect to the pressure-receiving surface, the abutting surface including: an electrode section capable of electrifying the first metal member; and an insulating section configured from an insulating material, the pressure-receiving surface including a non-contact-with-electrode section that does not contact the electrode section, the non-contact-with-electrode section containing a shortest portion where a distance between the pressure-receiving surface and the joining interface will be shortest, and the insulating section contacting at least part of the non-contact-with-electrode section.

A second aspect of the present invention is a joining apparatus by which a first metal member provided with a pressure-receiving surface and a joining interface inclining with respect to the pressure-receiving surface is joined to a second metal member by electrification and pressurization, the joining apparatus comprising an electrifying/pressurizing head provided with an abutting surface that contacts the pressure-receiving surface, the abutting surface including: an electrode section capable of electrifying the first metal member; and an insulating section configured from an insulating material, and the insulating section being arranged in such a manner that a shortest distance between a region abutted on by the insulating section of the pressure-receiving surface and the joining interface will be shorter than a shortest distance between a region abutted on by the electrode section of the pressure-receiving surface and the joining interface.

A third aspect of the present invention is a method of joining that, by electrification and pressurization employing an electrifying/pressurizing head provided with an abutting surface contacting a pressure-receiving surface of a first metal member, joins the first metal member and a second metal member, and obtains a joined body in which a joining interface inclines with respect to the pressure-receiving surface, the abutting surface being provided with: an electrode section capable of electrifying the first metal member; and an insulating section configured from an insulating material, the method of joining including: a contacting step in which the abutting surface is brought into contact with the pressure-receiving surface; and a joining step in which, by applying a pressurizing force in a pressurizing direction orthogonal to the pressure-receiving surface and performing electrification via the electrifying/pressurizing head, the first metal member and the second metal member are joined to form the joining interface, the abutting surface being brought into contact with the pressure-receiving surface in the contacting step in such a manner that a portion at least containing a shortest portion where a distance from the joining interface will be shortest, of the pressure-receiving surface will be a non-contact-with-electrode section of non-contact with the electrode section, and in such a manner that the insulating section contacts at least part of the non-contact-with-electrode section.

Due to the joining apparatus and the method of joining of the present invention, the insulating section is provided at a certain position in the abutting surface of the electrifying/pressurizing head, hence an adjacent region being a region closest to the pressure-receiving surface of the joining interface can be distanced from the electrode section. Therefore, an electrification distance from the electrode section to the adjacent region can be lengthened. Consequently, it can be suppressed that a generated heat amount of the adjacent region will become larger than that of another portion of the joining interface. As a result, it can be suppressed that variation occurs in the generated heat amount of the joining interface, hence the first metal member and the second metal member can be favorably joined.

Moreover, not only the electrode section but also the insulating section can be brought into contact with the pressure-receiving surface of the first metal member to apply the pressurizing force to the pressure-receiving surface of the first metal member, hence it becomes possible for occurrence of bending, and so on, of the first metal member, and so on, to be suppressed during electrification and pressurization, whereby it becomes possible for the first metal member and the second metal member to be favorably joined.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a principal part schematic configuration diagram of a joining apparatus according to an embodiment of the present invention; FIG. 2 is a cross-sectional view of a valve seat material (a first metal member) and a cylinder head main body (a second metal member) capable of being joined by applying the joining apparatus of FIG. 1;

FIG. 3 is a principal part enlarged cross-sectional view of a cylinder head obtained by processing a joined body joining the valve seat material and the cylinder head main body of FIG. 2;

FIG. 4 is a principal part schematic cross-sectional view of an electrifying/pressurizing head of the joining apparatus of FIG. 1;

FIG. 5 is a bottom view of the electrifying/pressurizing head of FIG. 4;

FIG. 6 is a flowchart showing one example of a method of joining according to the embodiment of the present invention;

FIG. 7 is an explanatory drawing that explains what it looks like when an abutting surface of the electrifying/pressurizing head has been brought into contact with a pressure-receiving surface of the valve seat material, and a first joining surface of the valve seat material and a projection provided in a second joining surface of the cylinder head main body have been abutted on each other;

FIG. 8 is an explanatory drawing that explains what it looks like when the projection of FIG. 7 has been melted to bring the valve seat material and the cylinder head main body close to each other; and

FIG. 9 is an explanatory drawing that explains what it looks like when the valve seat material and the cylinder head main body of FIG. 8 have been further brought close to each other to form a joining interface between the first joining surface and the second joining surface.

### DESCRIPTION OF THE PREFERRED EMBODIMENTS

A preferred embodiment of a joining apparatus and a method of joining according to the present invention will be presented and described in detail with reference to the accompanying drawings. Note that in the drawings below, configuration elements displaying the same or similar functions and advantages will be assigned with the same reference symbols, and repeated descriptions thereof will sometimes be omitted.

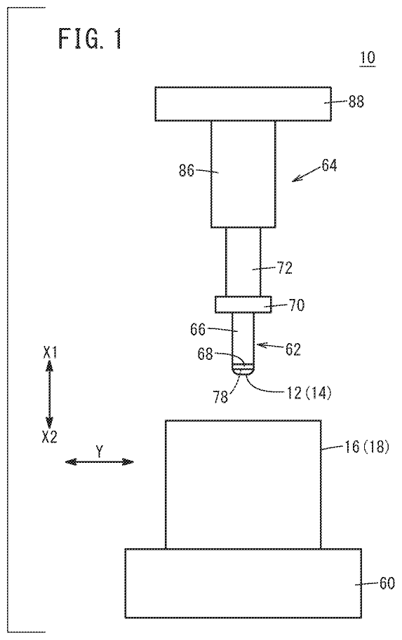

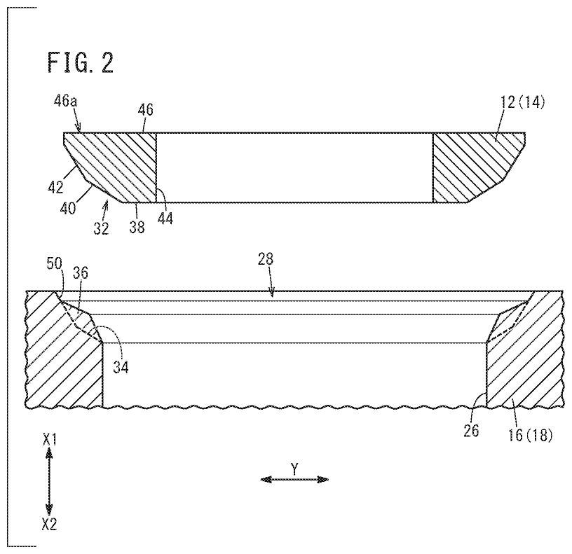

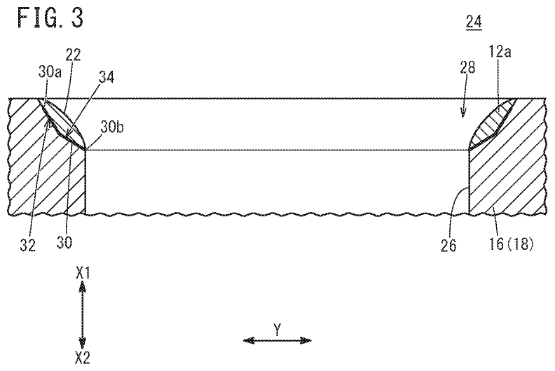

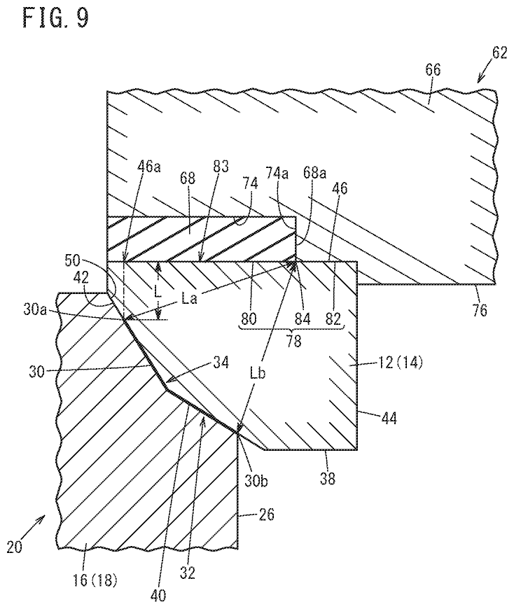

Described below is an example where, by applying a joining apparatus 10 according to the present embodiment shown in FIG. 1, a first metal member 14 being a work (hereafter, also called a “valve seat material 12”) eventually processed into a valve seat 12a (refer to FIG. 3) and a second metal member 18 being a cylinder head main body 16 are joined to obtain a joined body 20 (refer to FIG. 9). By, for example, performing machining, and so on, using the likes of an unillustrated cutting apparatus, on the joined body 20 obtained using the joining apparatus 10 and, as shown in FIG. 3, forming a valve abutting surface 22 in the valve seat material 12, a cylinder head 24 including the valve seat 12a is obtained.

However, the first metal member 14 and the second metal member 18 capable of being joined by applying the joining apparatus 10 are not limited to the valve seat material 12 and the cylinder head main body 16.

First, the cylinder head 24 will be briefly described with reference to FIG. 3. Ports 26 whose one end sides (an arrow X1 side) respectively open toward an unillustrated combustion chamber are formed in the cylinder head main body 16. The valve seat 12a which is circular ring-shaped is inserted into an insertion port 28 being an opening circumferential edge section on the one end side (the arrow X1 side) of a port 26. An outer circumferential surface of said valve seat 12a and an inner circumferential surface of the insertion port 28 are joined via a joining interface 30. Specifically, a first joining surface 32 provided in the outer circumferential surface of the valve seat 12a and a second joining surface 34 provided in the inner circumferential surface of the insertion port 28 are joined via the joining interface 30.

In the cylinder head 24, the valve seat 12a is provided with the valve abutting surface 22 that inclines in a diameter-increasing direction toward a combustion chamber side, and by an unillustrated valve being seated in or separating from said valve abutting surface 22, the port 26 is configured capable of opening/closing. In other words, in the cylinder head 24, the valve seat 12a is joined to a position abutted on by the valve of the cylinder head main body 16.

Next, the valve seat material 12 and the cylinder head main body 16 before joining, in other words, before becoming the joined body 20 (refer to FIG. 9) will be described with reference to FIGS. 2, and 7-9. As shown in FIG. 2, in the valve seat material 12 before joining, the valve abutting surface 22 (refer to FIG. 3) is not formed. Moreover, in the cylinder head main body 16 before joining, a projection 36 is provided in the second joining surface 34.

Note that as shown in FIG. 2, the valve seat material 12 is inserted in the insertion port 28 from one end side (the arrow X1 side) toward the other end side (an arrow X2 side) in an axial direction of the insertion port 28, in a state of having been disposed in such a manner that their mutual axial directions (an arrow X1-X2 direction) will coincide and their mutual radial directions (an arrow Y direction) will be parallel.

Hereafter, regarding the valve seat material 12, a tip side in an inserting direction when said valve seat material 12 is inserted into the insertion port 28 (the arrow X2 side) will also simply be called a distal end side, and a base end side in a reverse of said inserting direction (the arrow X1 side) will also simply be called a proximal end side. Moreover, an outer side in the radial direction (the arrow Y direction) of the valve seat material 12 and the insertion port 28 will also simply be called an outer side, and a center side in the radial direction (the arrow Y direction) of the valve seat material 12 and the insertion port 28 will also simply be called a center side.

The valve seat material 12 is circular ring-shaped being configured from a sintered body of an iron-based material such as a steel material, for example. Note that the valve seat material 12 may further include a high electrical conductivity material such as a copper-based material. As shown in FIG. 2, a distal end surface 38 of the valve seat material 12 has a planar direction lying along the radial direction of the valve seat material 12.

An outer circumferential surface of the valve seat material 12 is provided with a first tapered section 40 and a second tapered section 42 whose planar directions differ from each other. The first tapered section 40 and the second tapered section 42 each have a tapered shape whose diameter decreases from the proximal end side to the distal end side. The first tapered section 40 is disposed more to the distal end side than the second tapered section 42 is, and a proximal end section of the first tapered section 40 and a distal end section of the second tapered section 42 coincide. A distal end section of the first tapered section 40 coincides with an end section on the outer side of the distal end surface 38.

As shown in FIG. 9, in the valve seat material 12, a portion on the proximal end side of the first tapered section 40 and a portion on the distal end side of the second tapered section 42 will be the first joining surface 32. As shown in FIG. 2, the center side of the valve seat material 12 is provided with a through-hole 44 along the axial direction. A pressure-receiving surface 46 being an end surface on the proximal end side of the valve seat material 12 has its planar direction orthogonal to the axial direction (the arrow X1-X2 direction).

The cylinder head main body 16 is configured from an aluminum-based material of the likes of pure aluminum or an aluminum alloy, for example. As shown in FIG. 2, an inner circumferential surface of the insertion port 28 of the cylinder head main body 16 is provided with: the projection 36 projecting in a circular ring-shaped manner; and a taper surface 50. During joining of the valve seat material 12 and the cylinder head main body 16, the projection 36 disappears, and the second joining surface 34 is formed instead. When the joining interface 30 has been formed (refer to FIG. 9), the second joining surface 34 has a shape following the first joining surface 32 of the valve seat material 12.

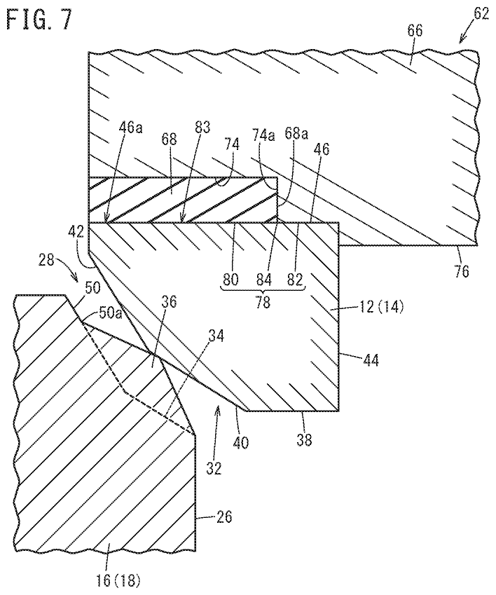

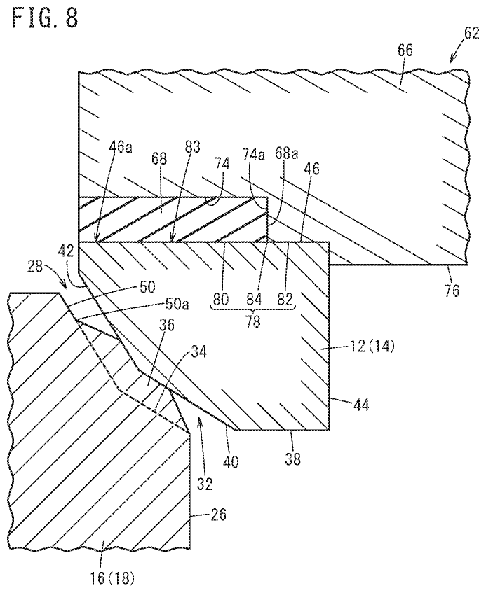

The taper surface 50 has a tapered shape extending in a diameter-increasing direction of the insertion port 28, from an end section on the proximal end side (the arrow X1 direction side) of the second joining surface 34, further toward the proximal end side. By, for example, the taper surface 50 and the second tapered section 42 of the valve seat material 12 having their mutual taper angle made substantially equal, or having an inclination angle of the second tapered section 42 of the valve seat material 12 with respect to an axial direction of the taper surface 50 slightly increased, and so on, the taper surface 50 and the second tapered section 42 of the valve seat material 12 have each of their shapes set in such a manner that the valve seat material 12 and the cylinder head main body 16 will be in a desired joining position relationship when a center side end section 50a (refer to FIGS. 7 and 8) of the taper surface 50 and the second tapered section 42 have been abutted on each other.

As shown in FIG. 9, in the joined body 20, the valve seat material 12 and the cylinder head main body 16 are joined via the joining interface 30, and the valve abutting surface 22 (refer to FIG. 3) is not provided in the valve seat material 12. That is, in the valve seat material 12 of the joined body 20, a portion on the center side thereof has not been removed by cutting. In the joined body 20, a planar direction of the joining interface 30 is inclined with respect to a planar direction of the pressure-receiving surface 46 of the valve seat material 12.

Specifically, the joining interface 30 inclines with respect to the pressure-receiving surface 46 in such a manner that an outer end section 30a being an end section on the outer side of the joining interface 30 comes closest to the pressure-receiving surface 46, and an inner end section 30b being an end section on the center side of the joining interface 30 is furthest away from the pressure-receiving surface 46. Therefore, a distance along the axial direction (the arrow X1-X2 direction, a later-mentioned pressurizing direction) between the joining interface 30 and the pressure-receiving surface 46 will be shortest at the outer end section 30a, and will be longest at the inner end section 30b. In other words, in the joining interface 30, the outer end section 30a comes closest to the pressure-receiving surface 46, and the inner end section 30b is furthest away from the pressure-receiving surface 46.

Next, the joining apparatus 10 will be described with additional reference to FIGS. 1, 4, and 5. The joining apparatus 10 shown in FIG. 1 is capable of resistance welding the valve seat material 12 and the cylinder head main body 16 by performing electrification, while pressurizing the valve seat material 12 and the cylinder head main body 16 with the axial direction as the pressurizing direction (the arrow X1-X2 direction), and mainly includes: an electrode structure 60; an electrifying/pressurizing head 62; a pressurizing means 64; and an unillustrated power supply, or the like.

The cylinder head main body 16 is set in the electrode structure 60. At this time, the electrode structure 60 and the cylinder head main body 16 contact each other to achieve an electrically connected state. The insertion port 28 of the cylinder head main body 16 that has been set in the electrode structure 60 faces an electrifying/pressurizing head 62 side.

As shown in FIG. 1, the electrifying/pressurizing head 62 is configured by integrating an electrode member 66 and an insulating member 68. The electrode member 66 has a substantially circular columnar shape, and has its one end side in the axial direction (the arrow X1 side) fixed to a piston rod 72 of the pressurizing means 64, via a holder 70.

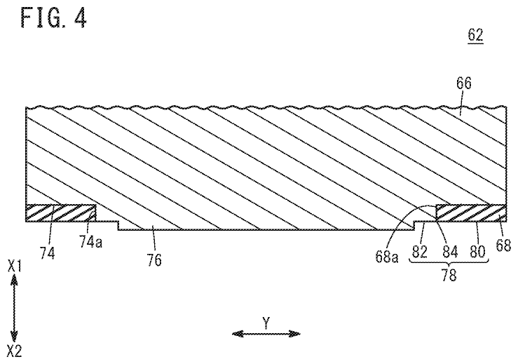

As shown in FIG. 4, in an end surface on the other end side in the axial direction (the arrow X2 side) of the electrode member 66, a circular ring-shaped notch 74 is provided so as to circle an outer circumferential edge, and a projecting section 76 is arranged projecting to the center side in a radial direction. By the insulating member 68, which is circular ring-shaped and configured from an insulating material, being inserted into the notch 74, the electrode member 66 and the insulating member 68 are integrated. Note that the electrode member 66 and the insulating member 68 may be integrated by fitting, or may be integrated by adhesion using an adhesive agent, or the like.

The projecting section 76 is set to dimensions enabling it to be inserted into the through-hole 44 (refer to FIG. 7, and so on) of the valve seat material 12. During electrification and pressurization using the joining apparatus 10, the electrifying/pressurizing head 62 and the valve seat material 12 are positioned by the projecting section 76 being inserted into the through-hole 44 of the valve seat material 12, as will be mentioned later.

In the electrifying/pressurizing head 62, a portion excluding the projecting section 76, of an end surface on the other end side in the axial direction, will be an abutting surface 78 that abuts on the pressure-receiving surface 46 of the valve seat material 12 during electrification and pressurization. The abutting surface 78 is a planar surface orthogonal to the axial direction of the electrifying/pressurizing head 62. In this abutting surface 78, an end surface on the other end side (the arrow X2 side) in the axial direction of the insulating member 68 will be an insulating section 80, and a portion excluding the projecting section 76 of an end surface on the other end side in the axial direction of the electrode member 66 will be an electrode section 82. As shown in FIG. 9, the notch 74 faces a portion at least including a shortest portion 46a being a place where a distance from the joining interface 30 will be shortest, of the pressure-receiving surface 46. That is, a portion facing the notch 74, of the pressure-receiving surface 46, will be a non-contact-with-electrode section 83 having non-contact with the electrode section 82.

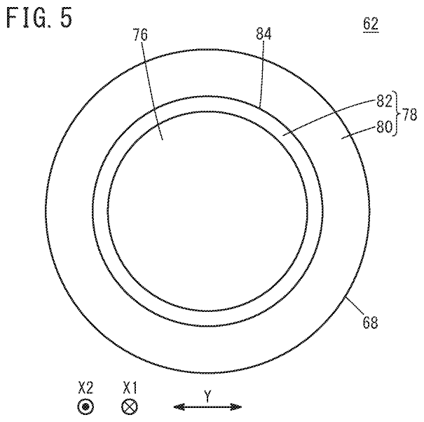

As shown in FIG. 4, an inner circumferential surface 68a of the insulating member 68 abuts on a level difference surface 74a of the notch 74, and is formed flush with the electrode section 82 and the insulating section 80. As shown in FIG. 5, the insulating section 80 is circular ring-shaped being arranged circling an outer circumferential edge of the abutting surface 78, and the electrode section 82 is circular ring-shaped being arranged between the insulating section 80 and the projecting section 76. Hence, the abutting surface 78 configured by the insulating section 80 and the electrode section 82 is circular ring-shaped.

As shown in FIG. 9, the insulating section 80 provided on an inside of the notch 74 is arranged in the abutting surface 78 so as to abut on the non-contact-with-electrode section 83 of the pressure-receiving surface 46. Hence, the insulating section 80 is arranged in such a manner that a shortest distance between a region abutted on by the insulating section 80 of the pressure-receiving surface 46 and the joining interface 30 will be shorter than a shortest distance between a region abutted on by the electrode section 82 of the pressure-receiving surface 46 and the joining interface 30. That is, the insulating section 80 is arranged in such a manner that a shortest distance La between an end section on an insulating section 80 side of the electrode section 82 and the outer end section 30a of the joining interface 30 being a region of the joining interface 30 closest to the pressure-receiving surface 46 will be longer than a shortest distance L between the outer end section 30a and the pressure-receiving surface 46. Moreover, a boundary 84 of the non-contact-with-electrode section 83 and a portion contacting the electrode section 82, of the pressure-receiving surface 46 (an end section on an insulating section 80 side of the electrode section 82), is arranged in the abutting surface 78 in such a manner that the shortest distance La to the outer end section 30a of the joining interface 30 and a shortest distance Lb to the inner end section 30b of the joining interface 30 will be substantially equal.

As shown in FIG. 1, the pressurizing means 64 includes a pressurizing cylinder 86 configured from the likes of a hydraulic cylinder or an air cylinder, for example. One end side (the arrow X1 side) of the pressurizing cylinder 86 is fixed to a support 88, and the other end side (the arrow X2 side) of the pressurizing cylinder 86 is provided with the piston rod 72 which is capable of advancing/retracting in the pressurizing direction. The electrifying/pressurizing head 62 is fixed to the other end side of the piston rod 72, via the holder 70.

Therefore, in the pressurizing means 64, by advancing the piston rod 72, the electrifying/pressurizing head 62 and the electrode structure 60 can be relatively brought close to each other along the pressurizing direction. As a result, a pressurizing force is applied to the valve seat material 12 and the cylinder head main body 16 that have been set between the abutting surface 78 of the electrifying/pressurizing head 62 and the electrode structure 60.

The power supply is electrically connected to the electrode member 66 of the electrifying/pressurizing head 62 and to the electrode structure 60. By switching on the power supply, electrification can be performed between the electrode section 82 and the electrode structure 60. As a result, a current flows from the valve seat material 12 to the cylinder head main body 16 via the pressure-receiving surface 46 contacting the electrode section 82.

Next, a method of joining that joins the valve seat material 12 and the cylinder head main body 16 using the joining apparatus 10 will be described mainly with reference to FIGS. 1, and 6-9.

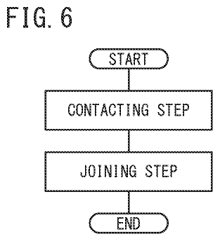

As shown in FIG. 6, this method of joining includes a contacting step and a joining step. In the contacting step, as shown in FIG. 7, the projecting section 76 of the electrifying/pressurizing head 62 is inserted into the through-hole 44 of the valve seat material 12, and the abutting surface 78 is brought into contact with the pressure-receiving surface 46. The insulating section 80 and the electrode section 82 are arranged as described above, in the abutting surface 78. Therefore, the insulating section 80 contacts the non-contact-with-electrode section 83, of the pressure-receiving surface 46. Moreover, as shown in FIG. 1, the cylinder head main body 16 is set in the electrode structure 60 to bring them into contact with each other.

As shown in FIG. 7, the taper surface 50 of the cylinder head main body 16 and the second tapered section 42 of the valve seat material 12 are faced against each other at an interval, and an apex of the projection 36 is abutted on the first tapered section 40 (the first joining surface 32), between the electrode structure 60 and the abutting surface 78 of the electrifying/pressurizing head 62. Note that the contacting step may be performed before the first tapered section 40 and the projection 36 are abutted on each other, or may be performed in a state that the first tapered section 40 and the projection 36 have been abutted on each other.

Next, in the joining step, the abutting surface 78 and the electrode structure 60 are relatively brought close to each other under action of the pressurizing means 64 shown in FIG. 1, thereby applying a pressurizing force in the pressurizing direction orthogonal to the pressure-receiving surface 46 shown in FIG. 7, and so on. Moreover, in the joining step, the power supply is switched on to perform electrification between the electrode section 82 (refer to FIG. 7) and the electrode structure 60 (refer to FIG. 1).

As a result, when resistance welding is started, a contact section of the valve seat material 12 and the cylinder head main body 16 generates heat based on contact resistance, and the projection 36 begins to melt, as shown in FIG. 8. When the valve seat material 12 and the cylinder head main body 16 are brought close to each other while the melted projection 36 is being discharged from between the first joining surface 32 and the second joining surface 34, a contact area of the melted projection 36 and the first joining surface 32 increases, as shown in FIG. 8.

Then, when substantially the whole of the projection 36 melts, the joining interface 30 is formed between the first joining surface 32 and the second joining surface 34, and a region of the second tapered section 42 more to the one end side than the first joining surface 32 is and the center side end section 50a (refer to FIG. 8) of the taper surface 50 are abutted on each other, as shown in FIG. 9. Resistance welding is finished by stopping electrification at a timing immediately before the region of the second tapered section 42 more to the one end side than the first joining surface 32 is and the center side end section 50a make contact in this way, or simultaneously with their contact. As a result, the joined body 20 can be obtained with the valve seat material 12 and the cylinder head main body 16 joined with a desired positional relationship.

Next, operational advantages of the joining apparatus 10 and the method of joining according to the present embodiment will be described. In these joining apparatus 10 and method of joining, a place including at least the shortest portion 46a of the pressure-receiving surface 46 is configured as the non-contact-with-electrode section 83 not contacting the electrode section 82, whereby the outer end section 30a being an adjacent region closest to the pressure-receiving surface 46 of the joining interface 30 can be distanced from the electrode section 82. Therefore, an electrification distance from the electrode section 82 to the outer end section 30a can be lengthened, hence it can be suppressed that a generated heat amount of the outer end section 30a becomes larger than that of another region of the joining interface 30. As a result, it can be suppressed that variation occurs in the generated heat amount of the joining interface 30, hence it becomes possible for the valve seat material 12 and the cylinder head main body 16 to be favorably joined.

Moreover, even when the non-contact-with-electrode section 83 is provided in the pressure-receiving surface 46 in order to suppress variation in the generated heat amount of the joining interface 30 in the above-described way, the insulating section 80 can be brought into contact with said non-contact-with-electrode section 83 to apply the pressurizing force to the non-contact-with-electrode section 83. As a result, it can be suppressed that the pressurizing force is unevenly applied from the abutting surface 78 to the pressure-receiving surface 46. Furthermore, by the pressure-receiving surface 46 being orthogonal to the pressurizing direction, the pressurizing force can be applied effectively and stably. These points too result in it being suppressed that bending, and so on, occurs in the valve seat material 12, and so on, during electrification and pressurization, thereby making it possible for the valve seat material 12 and the cylinder head main body 16 to be favorably joined.

In the joining apparatus 10 according to the above-described embodiment, the first metal member 14 (the valve seat material 12) is provided with the through-hole 44 along its axial direction, and is circular ring-shaped having the pressure-receiving surface 46 as its one end surface in the axial direction. Tapered sections (the first tapered section 40 and the second tapered section 42) whose diameters decrease from a pressure-receiving surface 46 side toward the other end surface (the distal end surface 38) side in the axial direction are provided for the outer circumferential surface of the valve seat material 12. The second metal member 18 (the cylinder head main body 16) includes the insertion port 28 into which the valve seat material 12 is inserted along the axial direction. The joining interface 30 is provided between the outer circumferential surface including the first tapered section 40 and second tapered section 42 of the valve seat material 12 and the inner circumferential surface of the insertion port 28 of the cylinder head main body 16. The insulating section 80 is circular ring-shaped being arranged circling the outer circumferential edge of the abutting surface 78.

Moreover, in the method of joining according to the above-described embodiment, the first metal member 14 (the valve seat material 12) is provided with the through-hole 44 along its axial direction, and is circular ring-shaped having the pressure-receiving surface 46 as its one end surface in the axial direction. Tapered sections (the first tapered section 40 and the second tapered section 42) whose diameters decrease from a pressure-receiving surface 46 side toward the other end surface (the distal end surface 38) side in the axial direction are provided for the outer circumferential surface of the valve seat material 12. The second metal member 18 (the cylinder head main body 16) includes the insertion port 28 into which the valve seat material 12 is inserted along the axial direction. In the contacting step, the circular ring-shaped insulating section 80 arranged circling the outer circumferential edge section of the abutting surface 78 is brought into contact with the non-contact-with-electrode section 83. In the joining step, the joining interface 30 is formed between the outer circumferential surface including the first tapered section 40 and second tapered section 42 of the valve seat material 12 and the inner circumferential surface of the insertion port 28 of the cylinder head main body 16.

The joining apparatus 10 and the method of joining using the joining apparatus 10 are capable of being particularly suitably applied in the case where, as described above, the joined body 20 is obtained by forming the joining interface 30 between the outer circumferential surface including the first tapered section 40 and second tapered section 42 of the valve seat material 12 and the inner circumferential surface of the insertion port 28 of the cylinder head main body 16.

That is, by providing the abutting surface 78 with the circular ring-shaped insulating section 80 circling the outer circumferential edge of the abutting surface 78 as shown in FIG. 5, the insulating section 80 can be easily brought into contact with a portion at least including the shortest portion 46a of the pressure-receiving surface 46, as shown in FIG. 9. As a result, it can be suppressed that variation occurs in the generated heat amount of the joining interface 30, or that bending, and so on, occurs in the valve seat material 12, and so on, during electrification and pressurization, and it is thereby possible for the valve seat material 12 and the cylinder head main body 16 to be favorably joined.

The electrifying/pressurizing head 62 includes: the electrode member 66 provided with the electrode section 82; and the circular ring-shaped insulating member 68 whose one end surface is provided with the insulating section 80. In the end section on the side where the abutting surface 78 is provided of the electrifying/pressurizing head 62, the outer circumferential edge of the electrode member 66 is provided with the circular ring-shaped notch 74, and the insulating member 68 is disposed in said notch 74. This configuration makes it possible for the insulating section 80 to be accurately and simply disposed in a desired position during assembly of the electrifying/pressurizing head 62.

The inner circumferential surface 68a of the insulating member 68 abuts on the level difference surface 74a of the notch 74, and is formed flush with the electrode section 82 and the insulating section 80. That is, the insulating section 80 contacts the whole of the non-contact-with-electrode section 83. This configuration enables an abutting area of the abutting surface 78 on the pressure-receiving surface 46 to be further broadened, hence the pressurizing force can be even more effectively applied.

In the joining apparatus 10 according to the above-described embodiment, the distance between the joining interface 30 and the pressure-receiving surface 46 will be shortest at the outer end section 30a of the joining interface 30 disposed on the outer side in the radial direction of the first metal member 14 (the valve seat material 12), and will be longest at the inner end section 30b of the joining interface 30 disposed on the center side in the radial direction of the first metal member 14 (the valve seat material 12). The boundary of the non-contact-with-electrode section 83 and the portion contacting the electrode section 82, of the pressure-receiving surface 46, in other words, the region that the boundary 84 of the abutting surface 78 contacts, of the pressure-receiving surface 46, is arranged in such a manner that the shortest distance La to the outer end section 30a and the shortest distance Lb to the inner end section 30b will be substantially equal.

In the method of joining according to the above-described embodiment, the distance along the pressurizing direction between the joining interface 30 and the pressure-receiving surface 46 will be shortest at the outer end section 30a of the joining interface 30 disposed on the outer side in the radial direction of the first metal member 14 (the valve seat material 12), and will be longest at the inner end section 30b of the joining interface 30 disposed on the center side in the radial direction of the first metal member 14 (the valve seat material 12). In the contacting step, the abutting surface 78 is brought into contact with the pressure-receiving surface 46 in such a manner that the shortest distance La from the boundary 84 to the outer end section 30a and the shortest distance Lb from the boundary 84 to the inner end section 30b will be substantially equal.

Arranging the boundary 84 as described above makes it possible to achieve equalization of the electrification distance in the whole of the joining interface 30, hence it can be more effectively suppressed that variation occurs in the generated heat amount of the joining interface 30. As a result, the valve seat material 12 and the cylinder head main body 16 can be even more favorably joined.

The present invention is not particularly limited to the above-described embodiment, and may be modified variously in a range not departing from the spirit of the present invention.

For example, the insulating section 80 is not limited to being circular ring-shaped, and need only have a shape enabling it to contact at least part of the non-contact-with-electrode section 83 of the pressure-receiving surface 46. Moreover, the shape of the outer circumferential surface of the valve seat material 12 is not limited to that of the above-described embodiment. One tapered section may be provided instead of two tapered sections, that is, the first tapered section 40 and the second tapered section 42 whose planar directions differ from each other, or three or more tapered sections may be provided. Moreover, an arc section may be provided instead of the first tapered section 40 and the second tapered section 42.

Although, in the above-described embodiment, a configuration was adopted that the distance between the joining interface 30 and the pressure-receiving surface 46 will be shortest at the outer end section 30a and will be longest at the inner end section 30b, the present invention is not particularly limited to this. For example, a configuration may be adopted in which the distance between the joining interface 30 and the pressure-receiving surface 46 will be longest at the outer end section 30a and will be shortest at the inner end section 30b. In this case, similar operational advantages to those of the above-described embodiment can be obtained by arranging the electrode section 82 so as to circle the outer circumferential edge of the abutting surface 78, and by disposing the insulating section 80 on the center side of the electrode section 82.

A configuration was adopted that the joining interface 30 is provided between the outer circumferential surface including the first tapered section 40 and second tapered section 42 of the valve seat material 12 and the inner circumferential surface of the insertion port 28 of the cylinder head main body 16. That is, a configuration was adopted that the joining interface 30 has a shape corresponding to an outer circumferential surface of a truncated cone. However, the shape of the joining interface 30 is not particularly limited to this. If the first metal member 14 and the second metal member 18 are joined via a joining interface 30 having a portion inclining with respect to the planar direction of the pressure-receiving surface 46, then the joining apparatus and method of joining according to the present invention can be applied to obtain similar operational advantages to in the above-described embodiment.

What is claimed is:

1. A joining apparatus that comprises an electrifying/pressurizing head provided with an abutting surface contacting a pressure-receiving surface of a first metal member, and that joins the first metal member and a second metal member by electrification and pressurization employing the electrifying/pressurizing head, and obtains a joined body in which a joining interface inclines with respect to the pressure-receiving surface,
the abutting surface including: an electrode section capable of electrifying the first metal member; and an insulating section configured from an insulating material,
the pressure-receiving surface including a non-contact-with-electrode section that does not contact the electrode section, the non-contact-with-electrode section containing a shortest portion where a distance between the pressure-receiving surface and the joining interface will be shortest, and
the insulating section contacting at least part of the non-contact-with-electrode section.

2. The joining apparatus according to claim 1, wherein
the insulating section is arranged in such a manner that a shortest distance between an end section on an insulating section side of the electrode section and an adjacent region closest to the pressure-receiving surface of the joining interface will be longer than a shortest distance between the adjacent region and the pressure-receiving surface.

3. The joining apparatus according to claim 1, wherein
the insulating section contacts the whole of the non-contact-with-electrode section.

4. The joining apparatus according to claim 1, wherein
the first metal member is circular ring-shaped being provided with a through-hole along an axial direction thereof and having the pressure-receiving surface as an one end surface in the axial direction, and the first metal member has provided on an outer circumferential surface thereof a tapered section whose diameter decreases from a pressure-receiving surface side toward another end surface side in the axial direction,
the second metal member includes an insertion port into which the first metal member is inserted along the axial direction,
the joining interface is provided between an outer circumferential surface including the tapered section of the first metal member and an inner circumferential surface of the insertion port of the second metal member, and
the insulating section is circular ring-shaped being arranged circling an outer circumferential edge of the abutting surface.

5. The joining apparatus according to claim 4, wherein
the electrifying/pressurizing head includes: an electrode member provided with the electrode section; and a circular ring-shaped insulating member whose one end surface is provided with the insulating section,
a circular ring-shaped notch is provided in an outer circumferential edge of the electrode member, in an end section on a side where the abutting surface of the electrifying/pressurizing head is provided, and
the insulating member is disposed in the notch.

6. The joining apparatus according to claim 5, wherein
an inner circumferential surface of the insulating member abuts on a level difference surface of the notch, and
the electrode section and the insulating section are formed flush.

7. The joining apparatus according to claim 4, wherein
the distance between the joining interface and the pressure-receiving surface will be shortest at an outer end section of the joining interface disposed on an outer side in a radial direction of the first metal member, and will be longest at an inner end section of the joining interface disposed on a center side in the radial direction of the first metal member, and
a boundary of the non-contact-with-electrode section and a portion contacting the electrode section, of the pressure-receiving surface, is arranged in such a manner that a shortest distance to the outer end section and a shortest distance to the inner end section will be substantially equal.

8. A joining apparatus by which a first metal member provided with a pressure-receiving surface and a joining interface inclining with respect to the pressure-receiving surface is joined to a second metal member by electrification and pressurization, the joining apparatus comprising
an electrifying/pressurizing head provided with an abutting surface that contacts the pressure-receiving surface,
the abutting surface including: an electrode section capable of electrifying the first metal member; and an insulating section configured from an insulating material, and
the insulating section being arranged in such a manner that a shortest distance between a region abutted on by the insulating section, of the pressure-receiving surface, and the joining interface will be shorter than a shortest distance between a region abutted on by the electrode section, of the pressure-receiving surface, and the joining interface.

9. A method of joining that, by electrification and pressurization employing an electrifying/pressurizing head provided with an abutting surface contacting a pressure-receiving surface of a first metal member, joins the first metal member and a second metal member, and obtains a joined body in which a joining interface inclines with respect to the pressure-receiving surface,
the abutting surface being provided with: an electrode section capable of electrifying the first metal member; and an insulating section configured from an insulating material,
the method of joining including:
a contacting step in which the abutting surface is brought into contact with the pressure-receiving surface; and
a joining step in which, by applying a pressurizing force in a pressurizing direction orthogonal to the pressure-receiving surface and performing electrification via the electrifying/pressurizing head, the first metal member and the second metal member are joined to form the joining interface,
the abutting surface being brought into contact with the pressure-receiving surface in the contacting step in such a manner that a portion at least containing a shortest portion where a distance from the joining interface will be shortest, of the pressure-receiving surface, will be a non-contact-with-electrode section that does not contact with the electrode section, and in such a manner that the insulating section contacts at least part of the non-contact-with-electrode section.

10. The method of joining according to claim 9, wherein
the first metal member is circular ring-shaped being provided with a through-hole along an axial direction thereof and having the pressure-receiving surface as an one end surface in the axial direction, and the first metal member has provided on AN outer circumferential surface thereof a tapered section whose diameter decreases from a pressure-receiving surface side toward another end surface side in the axial direction,
the second metal member includes an insertion port into which the first metal member is inserted along the axial direction,
in the contacting step, the circular ring-shaped insulating section arranged circling an outer circumferential edge section of the abutting surface is brought into contact with at least part of the non-contact-with-electrode section, and
in the joining step, the joining interface is formed between an outer circumferential surface including the tapered section of the first metal member and an inner circumferential surface of the insertion port of the second metal member.

11. The method of joining according to claim 10, wherein
the distance between the joining interface and the pressure-receiving surface will be shortest at an outer end section of the joining interface disposed on an outer side in a radial direction of the first metal member, and will be longest at an inner end section of the joining interface disposed on a center side in the radial direction of the first metal member, and
in the contacting step, the abutting surface is brought into contact with the pressure-receiving surface in such a manner that a shortest distance from a boundary of the non-contact-with-electrode section and a portion contacting the electrode section, of the pressure-receiving surface, to the outer end section, and a shortest distance from the boundary to the inner end section will be substantially equal.
